(19) United States
(12) Patent Application Publication
(10) Pub. No.: US 2004/0236674 A1
(43) Pub. Date: Nov. 25, 2004

(54) Real-time credit authorization in e-commerce

(76) Inventors: Allen Chen, Cupertino, CA (US); Roland Oberdorfer, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/445,139

(22) Filed: May 23, 2003

(51) Int. Cl. G06F 17/60

(52) U.S. Cl. 705/38

(57) ABSTRACT

A method of real-time credit authorization for a plurality of e-commerce transactions. The method includes, in a credit authorization application running on a back-end business processing computer, receiving credit information related to a transaction provided by another computer having an e-commerce application. The method further includes opening an instance of a credit authorization module in the back-end system, processing the credit information in the module, and returning a credit authorization responsive to the credit information to the another computer system. The method may further include the receiving another instance of credit information related to a transaction, opening another instance of the credit authorization module in the back-end system, processing the another instance of credit information in the another module, and returning a credit authorization responsive to the another instance of credit information. The method is scalable and allows a plurality of instances of credit information to be processed simultaneously.

### BACKGROUND

Computer systems have evolved into extremely sophisticated devices, and are found in many different settings. The widespread proliferation of computers prompted the development of computer networks that allow computers to communicate with each other. With the introduction of the personal computer (PC), computing became accessible to large numbers of people. Networks for personal computers (PC) were developed that allow individual users to communicate with each other.

One significant computer network is the Internet, which grew out of this proliferation of computers and networks, and which has evolved into a sophisticated worldwide network of computer system resources commonly known as the “World-Wide-Web.” A user at an individual PC, i.e., client, who wishes to access the Internet typically does so using a software application known as a web browser. A web browser makes a connection, using the Internet, to other computers known as web servers, and receives from the web servers information that is rendered to the user's client.

Merchants have discovered the value of selling their goods and services over the Internet. E-commerce web sites have proliferated offering a broad range of goods and services on the Internet. Many e-commerce web sites allow shoppers to select and place goods in a virtual “shopping cart”, and when the shopper is prepared to finalize the purchase, they proceed to “checkout.” At this stage, all of the items in the shopper's cart are displayed with their prices, tax, shipping and handling, and total amount due. To purchase the items, the shopper then enters credit or bank-card information. The web site sends this credit information to the credit issuer's computer system, which then authenticates the credit/bank card and provides an authorization for the transaction, or denies the transaction. The web site typically does not finalize the purchase until it receives authorization from the credit issuer's computer system.

One problem with shopping on line is the delays that the web site sender encounters when obtaining credit authorization for a transaction in real-time while the shopper is still online. Existing e-commerce web site applications have a single queue for credit authorization, much like a single teller at a bank. Each shopper's credit authorization must “wait in line” until earlier transactions are processed. This often results in unacceptable delays in obtaining credit authorization, and large queues have been known to slow or crash an e-commerce web site.

Consequently, a need has arisen for a way to promptly obtain real-time credit authorization without overloading an e-commerce server.

### SUMMARY

In view of the foregoing, there is a need for a new and improved apparatus, system, and method for obtaining credit authorization that does not overload an e-commerce web site and provides real-time credit authorization for a transaction.

An embodiment of the invention provides a method of real-time credit authorization for a transaction. The method includes steps of receiving a plurality of credit-authorization requests with a computer system, each credit-authorization request including credit information related to a transaction, and processing more than one credit-authorization request at the same time with the computer system. The method may also include receiving at least two of the credit-authorization requests from different servers. The method may also include a step of returning a credit-authorization status responsive to each credit-authorization request.

Such a method allows an e-commerce web site to obtain real-time credit authorization for a plurality of transactions without overloading or crashing the website server. These and various other features as well as advantages of the present invention will be apparent from a reading of the following detailed description and a review of the associated drawings.

### BRIEF DESCRIPTION OF THE DRAWINGS

The invention, together with further objects and advantages thereof, may best be understood by making reference to the following description taken in conjunction with the accompanying drawings, in the several figures of which like referenced numerals identify like elements, and wherein:

FIG. 1 is a block diagram illustrating a conventional Internet-based shopping system that includes an e-commerce web site provided by a server, a customer client, a credit-issuer server, and a plurality of communication links;

FIG. 2 is a block diagram illustrating an Internet-based shopping system that includes an e-commerce web site having a back-end credit authentication servercredit-issuer server according to an embodiment of the invention; and

FIG. 3 is a diagram illustrating a logical flow for a real-time credit authorization application that can be executed by the back-end server of FIG. 2 according to an embodiment of the invention.

### DETAILED DESCRIPTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the present invention. The following detailed description is therefore not to be taken in a limiting sense, and the scope of the present invention is defined by the appended claims.

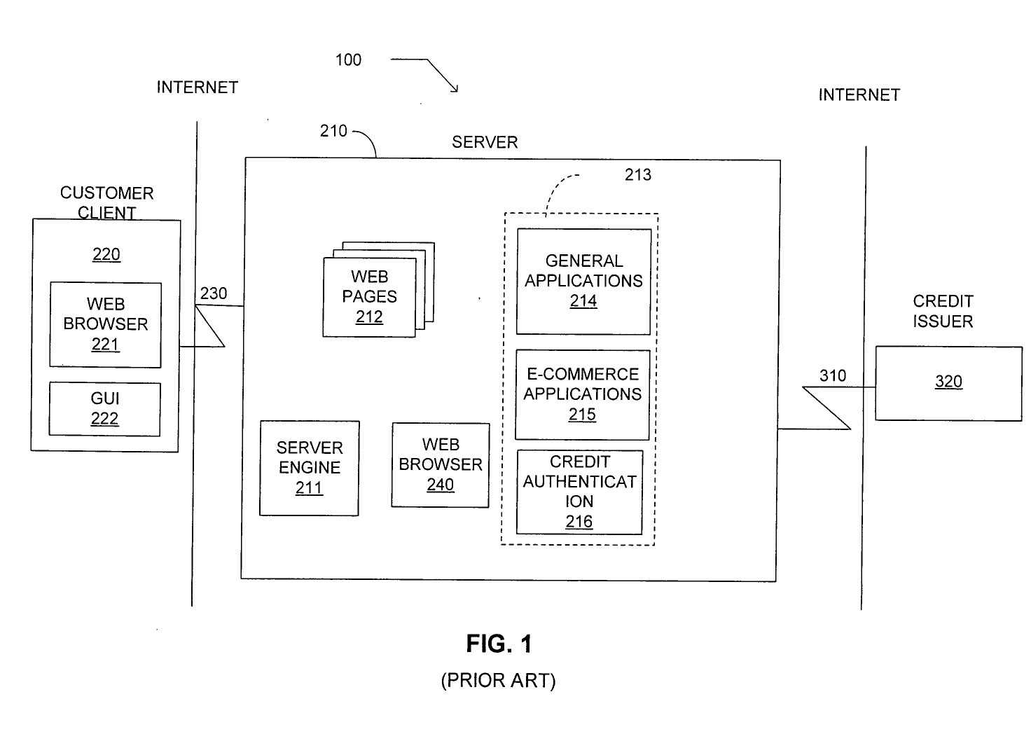

FIG. 1 is a block diagram illustrating a conventional Internet-based shopping system 100 that includes an e-commerce web site provided by a server 210, a customer client 220, a credit-issuer server 320, and communication links 230 and 310. This shopping system supports ordering products over the Internet using the World-Wide-Web.

The server 210 includes a server engine 211, various web pages 212, a storage unit 213 that stores general software applications 214, an e-commerce application 215, and a credit-authentication application 216, and a web browser 240 to communicate over the Internet with other servers, such as the credit-issuer server 320. The server engine 211 receives HTTP requests from the client 220 via the Internet to access web pages 212, which are identified by URLs, and provides the requested web pages to the client. The general applications 214 include such applications as are necessary to operate the server 210. The e-commerce applications 215 include such applications as are necessary to operate the server 210 as an e-commerce site. For example, these applications allow the server 210 to generate a shopping cart and to acquire a customer's credit information from the client 220. The credit-authentication application 216 allows the server 210 to contact the credit-issuer server 320 for authentication of the customer's credit information and authorization of a charge. Although only one customer client 220 is shown, the server system 210 is typically configured to interact with a plurality of customer clients simultaneously.

The customer client 220 typically includes a web browser 221, a graphical user interface (GUI) 222, and associated devices that allow the customer client to communicate with the server 210 using the Internet. The server 210 and customer client 220 interact by exchanging information using the communications link 230, which may include transmission over the Internet. Various communication links may be used, such as local-area network, wide-area network, or point-to-point dial-up connection. The customer client 220 may include any combination of hardware or software that allows the customer client 220 to interact with the server system 210.

The credit-issuer server 320 executes an application that responds to communications from a client, such as the credit authentication application 216 run by the server system 210. The credit-issuer server 320 may include any combination of hardware or software that allows interaction with the server system 210. The server system 210 and credit-issuer server 320 interact by exchanging information using the communications link 310, which may include transmission over the Internet. Various communication links may be used, such as local-area network, wide-area network, or point-to-point dial-up connection. The communications link 310 may be the same as the link 230, or link 310 may be a separate network communication link.

In operation, a customer uses the client 220 to browse the web pages 212 of the e-commerce web site maintained on the server 210. The customer selects goods and/or services for purchase, which are typically placed in a shopping cart. Once the customer completes selection of items in his shopping cart, the server 210 totals prices of all the products to determine a price of the purchase. Then the server 210 establishes a shipping charge for the transaction, any taxes and other add-on charges, and determines a total transaction price.

Once the server 210 determines the total transaction price, the customer provides the server system 210 with credit information via the client 220. The credit information includes information such as the customer's name, the billing address, a shipping address, and a credit-issuer identification, which is typically a credit card linked to a particular credit issuer such as a bank, although it may be some other form of credit.

The server 210 authenticates the credit information and obtains a credit authorization from the credit issuer to reserve funds for payment of the transaction price against the credit before completing the sale and releasing the goods and/or services for shipment to thecustomer.

If the credit issuer does not authenticate the credit information or denies the credit authorization, then the server 210 denies the purchase. Typically, a credit card cannot be charged for a purchase until the goods are shipped. If the goods will be shipped right away, the funds are transferred concurrently with the credit-authorization approval. When the goods cannot be shipped right away, there is a pre-authorization credit-approval phase where the funds are reserved for the e-commerce purchase at the time a transaction is confirmed, and a final-authorization phase charging the credit issuer 320 at the time the transaction is shipped and transferring the funds to the seller. A credit-authorization approval transfers funds of the credit issuer 220 (against the customer's credit) immediately for a completed transaction that will be shipped right away, or reserves funds for a period of time to await completion of the sale for a transaction that will be shipped in the future. For purposes of example, only a single authorization is described, which typically is a pre-authorization, but which may be final authorization when the goods will be shipped right away. Typically, after a pre-authorization is received and a transaction is confirmed, a final authorization is requested upon shipping. While embodiments of the invention described below focus on the initial contact with a credit issuer, these and other embodiments of the invention can also provide a second contact with the credit issuer 320 for a final authorization upon shipping after a pre-authorization credit approval was obtained.

Once the credit information is complete, authentication of the credit information and authorization of a charge against the credit of the purchaser are typically handed off to the credit authentication application 216. The credit-authentication application 216 also runs on the server 210, and as described earlier, has only a single queue for credit authorization much like a single teller at a bank. Each shopper's credit authorization must wait its turn in line until prior transactions are processed. This may result in unacceptable delays in obtaining credit authorization, and a long queue can slow or crash an e-commerce web site. Other delays may result if the credit issuer's server 320 is not functioning properly. Because of the delays resulting from the credit application 216 having a single queue, an e-commerce shopping session may be concluded before authentication of the credit information for the transaction is accomplished. This may require subsequent communication with the customer for correction of problems discovered during the credit-authorization process, such as mistakes in a shipping address or a credit-card number, or a notice that credit limit has been exceeded, and the like. This delays the customer's transaction and burdens the server 210 with extra tasks.

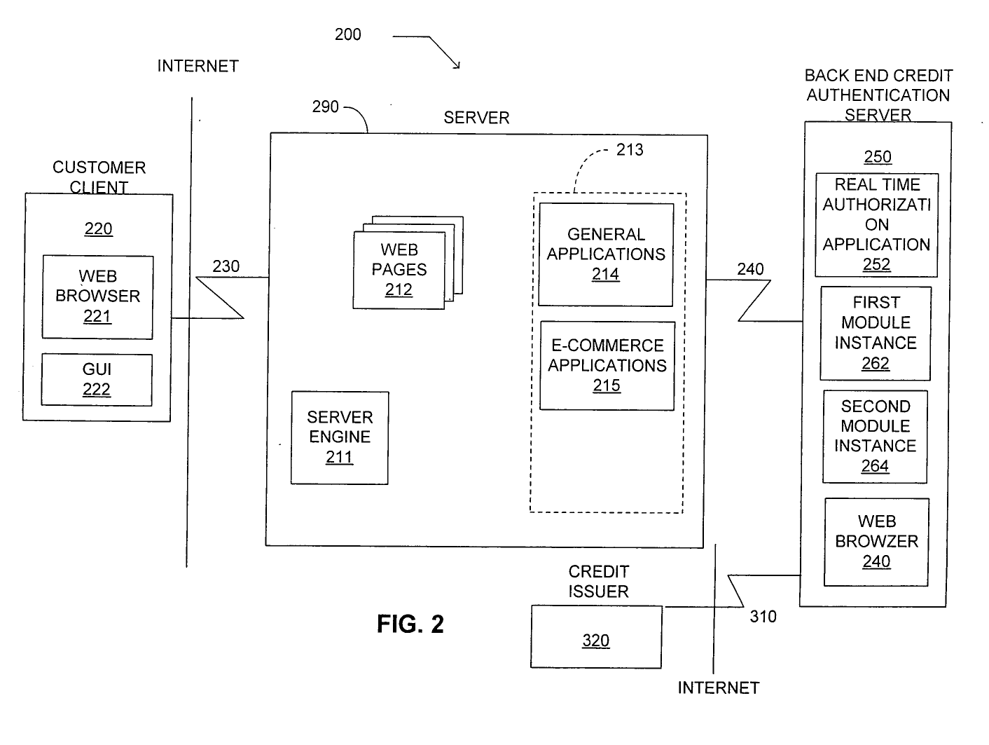

FIG. 2 is a block diagram illustrating an Internet-based shopping system 200 according to an embodiment of the invention. The system 200 includes an e-commerce web site provided by a server 290, a customer client 220, a back-end credit-authentication server 250, a credit-issuer server 320, and communication links 230, 240, and 310. The server 290, the customer client 220, and credit-issuer server 320 are similar to those of FIG. 1, except that the server 290 no longer runs the credit-authorization application 216,and the web browser 240 is run by the back-end authentication server 250.

The back-end credit-authentication server 250 runs a real-time authorization application 252 that is operable to simultaneously run multiple instances of a credit-authorization module for respective credit-authorization transactions. The multiple module instances are illustrated as a first module instance 262 and a second module instance 264, but the number of instances that may be simultaneously run may be greater than two. The server 250 also runs the web browser 240 for communication with the credit issuer via the communication link 310.

The real-time credit authentication application 252 is operable to open multiple instances of a credit authorization module, one module for each e-commerce transaction, much like providing one teller for each customer at a bank. Each module includes functionality operable to process credit information related to a transaction, including application of credit rules, to configure the credit information for contact with a credit issuer, and to contact the credit-issuer server 320 for authentication of the credit information and authorization of a charge. Once a credit-authorization status has been provided to the server 290 by a module of the application 252, that module may be either closed or used to process credit information related to another transaction. The server 250 also runs an operating system and applications typically providing functionality in a server. Although the number of modules that can be open and simultaneously processing credit information is theoretically unlimited, this number may be limited by the physical resources of the server 290 or other parameters,

The back-end credit authorization server 250 is coupled to the server 290 by the communications link 240, which allows the e-commerce applications 215 and the real-time credit-authorization application 252 to exchange information. The e-commerce applications 215 and the credit-authorization application 252 may be loosely coupled. The communications link 240 may include cabling coupling the two servers if they are in relatively close proximity, or may include a local-area network, a wide-area network, or point-to-point dial-up connection. The real-time credit-authorization application 252 comprises computer-executable instructions, and may be stored on a computer-readable medium such as floppy disc, a compact disc, or a DVD, or may be transmittable as a data signal, for loading into the server 250.

In operation, the Internet-based shopping system 200 operates similarly to the Internet-based shopping system 100 up to a point where the e-commerce applications 215 have complete credit information for a transaction. When the credit information is complete, the e-commerce applications 215 of server 290 provide the credit information related to the transaction to the back-end credit authentication server 250 over the communications link 240.

When the real-time credit authorization application 252, which is running on the back-end server 250, receives the credit information related to the transaction, it opens an instance of a credit-authentication module, such as the module 262. The module processes the credit information related to the transaction, communicates a request for credit information authentication and credit authorization to the credit issuer 320 over the communications link 310, receives a response from the credit issuer over the communications link 310, and returns a credit-authorization status over the communications link 240 to the server 290. The module may return the credit-authorization status to the application 252, which then returns the credit-authorization status to the e-commerce applications 252 over the communication link 240, or the module may return the credit-authorization status directly to the e-commerce applications 215.

If the real-time authorization application 252 receives another instance of credit information for another transaction from the e-commerce applications 215 or from another e-commerce application running on another server (not shown) while the first module instance 262 is processing a credit authorization for a previous transaction, then the application 252 opens another instance of a credit-authentication module such as the second module instance 264. The second module instance 264 processes the credit information after the new transaction simultaneously with the first module instance 262 processing the previous transaction. The number of modules running in the authentication server 250 is increased or decreased such that each instance of credit information is processed in a different module. The authentication server 250 may have several hundred modules open at a given time, each processing a different instance of credit information. If physical, resources, connections, or other factors limit the number of modules that may run at one time to less than the number of transactions awaiting approval, a queue is created. Alternatively, the application 252 may establish a limit on the number of modules that may be open at one time, and transactions not having an available module are placed in a queue for processing. However, because there are multiple modules running, the queue is shorter than if only a single module were running, as in the prior art server 210 of FIG.1.

In FIG. 2, the web browser 240 is illustrated as being run on the back-end server 250, and is used for communication with the credit-issuer server 320 over the Internet using communications link 310. In an alternative embodiment, the server 290 can include a web browser, such as the web browser 240, and the back-end server 250 can use the server 290 and its web browser for communication with the credit-issuer server 320.

While FIG. 2 illustrates a single back-end credit authentication server 250 for providing real-time credit-authorization services to one server 290 running e-commerce applications 215, alternative embodiments of the invention include one or more back-end credit authentication servers providing real-time credit authorization services to one or more servers running e-commerce applications.

The back-end credit-authentication server 250 helps to prevent credit-authentication functions from adversely impacting operation of the server 290 by processing credit-authentication functions. The real-time credit-authorization application 252 provides real-time authentication for a plurality of transactions by opening a separate authentication module for each transaction. Thus, the servers 250 and 290 are more likely to provide real-time credit authorization for a plurality of transactions, and less likely to be slowed or crashed than the conventional server 210 of FIG. 1 and a queue does form for credit authorization by the server 250, the wait will typically be less and will approach real-time because of the plurality of credit authorization modules available.

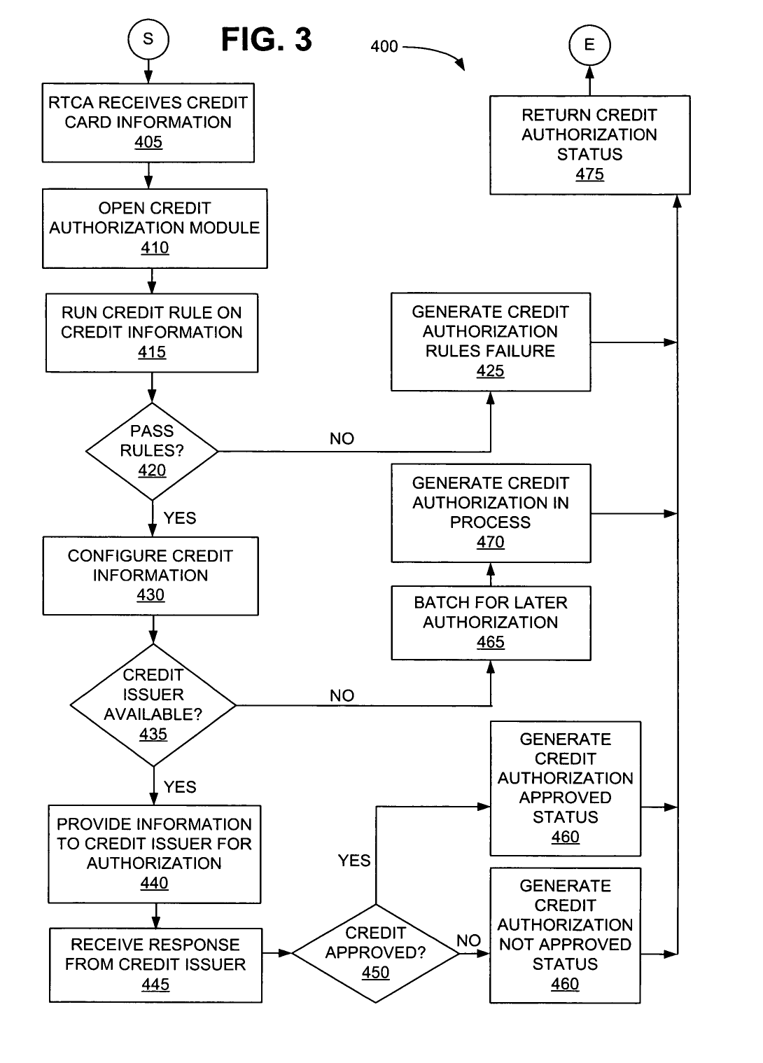

FIG. 3 is a diagram illustrating a logical flow 400 for the real-time creditauthorization application such 252 of FIG. 2 according to an embodiment of the invention. The real-time credit authorization application 252 is operable to return one of four statuses in response to a credit-authorization request; credit authorization approved; credit authorization not approved; credit authorization in process; and credit-rule failure. Other embodiments of the invention may be operable to return other statuses.

After a start block S, the logical flow moves to block 405 where credit information related to a purchase transaction is received from another computer system comprising an e-commerce application, such as the computer system 200 of FIG. 2. The credit information may include a transaction price, a shopper identification, a credit-issuer identification, a shipping address, a billing address, and a phone number. The logical flow moves to block 410 where an instance of a credit-authorization module is opened to process a credit-authorization, and the credit information is provided to the module instance. Next, the logical flow moves to block 415 where a credit rule is applied to the credit information. The credit rule is formulated to increase the accuracy of the credit information and diminish fraud or mistakes. The credit rule at block 415 may be a class of credit rules, each credit rule instance being formulated to check an aspect of the credit information, such as checking for completeness and fraud. For example, separate credit rule instances may check for a bad IP address, an IP address with a negative history, a shipping address with a negative history, mistakes in credit card numbers, or any other variable. By way of further example, a credit rule instance may include a minimum threshold. For example, a credit rule instance that checks the shipping address may ignore an unauthorized shipping address for transactions having a value of less than $100, but return a credit-rule failure when the value is at least $100 to the e-commerce application for correction or change by the customer. Some rule instances may result in the purchase being blocked, and other rule instances may result in the e-commerce server 290 requesting a correction or change from the customer.

Next, the logical flow moves to decision block 420. If the credit information passes the credit rule, the logical flow moves to block 430 where the module instance configures the credit information for communication to the credit issuer 320, if necessary. Otherwise, the logical flow moves to block 425 where a rules-failure status is generated. The logical flow then moves to block 475 where the real-time credit authorization application 252 receives the rules failure status and provides to the server 290 a credit-authorization rules failure, and optionally a reason for the failure. For example, if the failure to pass is because of a mistake in a shipping address, providing the rule failure to the e-commerce applications 215 allows the e-commerce application to request a correct address from the customer.

For credit information that passes the credit rules, the logical flow then moves from block 430 to decision block 435 where the availability of the credit issuer 320 identified in the credit information is ascertained for receiving the credit information and a request for authorization. The availability may be established by the module instance using the web browser 240 to communicate with the credit issuer 320 over communications link 310 as illustrated in FIG. 2. If the credit issuer 320 is available, the logical flow moves to block 440 where the credit information along with a request for a credit authorization in the amount of the transaction price is communicated to the credit issuer. Otherwise, the logical flow moves to block 465 where the credit information is batched for later communication to the credit issuer 320. Next, the logical flow moves to block 470 where an authorization-in-progress status is generated. The logical flow moves to block 475 where the real-time credit authorization application 252 receives the authorization-in-progress status and provides to the server 290 a credit authorization-in-progress status. In an alternative embodiment, the logical flow may move directly from block 430 to block 440 to provide the credit information and authorization request to the credit issuer 320 without first ascertaining whether the credit issuer is available for communication. In this alternative embodiment, a failure of the credit issuer 320 to respond within a predetermined time would result in a determination that the credit issuer is not available. If the credit issuer 320 is determined not to be available, the logic flow would move to blocks 465 and 470 for batching the information and generation of a credit authorization-in-process status.

The logical flow then moves from the block 440 to the block 445 where a response to the credit-authorization request is received from the credit issuer 320. The logical flow then moves to decision block 450. If the credit issuer 320 has returned a credit-authorization approved, the logical flow moves to the block 455 where a credit-authorization-approved status is generated. The logical flow moves to block 475 where the real-time credit authorization application 252 receives the credit-authorization-approved status and provides to the server 290 a credit approved for the corresponding transaction. Otherwise, the logical flow moves to the block 460, where a credit-authorization-not--approved status is generated. The logical flow then moves to block 475, where the real-time credit authorization application 252 receives the credit-authorization-not-approved status and provides to the server 290 a credit-authorization-not-approved status for the credit information. The logical flow then moves to an end block E.

Still referring to FIG. 3, if during the real-time credit authorization flow described above, another instance of credit information relating to a transaction is received at the block 405, the real-time-credit-authentication application 252 opens another instance of the credit-authorization module (such as the module 262) at block 410. The application 252 then processes the two instances of credit information at the same time, using separate modules according to the logical flow 400. As described previously in conjunction with FIG. 2, the logical flow 400 is scalable to independently process a plurality of instances of credit information simultaneously.

The various functions preferred by the back-end server 250 as described above may be implemented in software, in firmware, in special-purpose digital logic, or any combination thereof without deviating from the spirit or scope of the present invention.

Although the present invention is described in considerable detail with reference to certain embodiments, other embodiments are possible. Therefore, the spirit or scope of the appended claims should not be limited to the description of the embodiments contained herein.

What is claimed is:

1. A method, comprising:
receiving a plurality of credit-authorization requests with a computer system, each credit-authorization request including credit information related to a transaction; and
processing more than one credit-authorization request at the same time with the computer system.

2. The method of claim 1, wherein the computer system includes a back-end business processing server.

3. The method of claim 1, wherein at least two of the credit-authorization requests are received from different e-commerce servers.

4. The method of claim 1, further including a step of returning a credit-authorization status responsive to each credit-authorization request.

5. The method of claim 1, wherein the processing step includes the further steps of:
opening a credit-authorization module in the computer server for each authorization request;
processing each credit-authorization request in a different module; and returning a credit-authorization status for each credit-authorization request.

6. The method of claim 5, wherein the processing step further includes the steps of:
communicating the credit-authorization request to a credit issuer; and
receiving a response to a credit-authorization request from the credit issuer.

7. The method of claim 6, wherein the communicating step further includes a step of, if the credit issuer does not respond to the communicating step, storing the credit-authorization request for later communication with the credit issuer and returning an authorization-in-process status.

8. The method of claim 7, wherein the communicating step further includes a step of batching the credit-authorization request with another credit-authorization request for later communication with the credit issuer.

9. The method of claim 1, wherein the step of returning the credit-authorization status further includes a step of returning a credit-authorization approved status in response to a credit-authorization approval from the credit issuer.

10. The method of claim 9, otherwise returning a credit-authorization declined-status message.

11. The method of claim 1, wherein a credit-authorization request includes at least one of a transaction price, a customer identification, and a credit-issuer identification.

12. The method of claim 1, wherein the processing step further includes a step of applying a credit rule to the credit-authorization request.

13. A computer-readable medium having computer-executable instructions for performing steps comprising:
receiving a plurality of credit-authorization requests, each credit-authorization request including credit information related to a transaction; and
processing more than one credit-authorization request at the same time.

14. A computer system operable to:
receive a plurality of credit-authorization requests with a computer, each credit-authorization request including credit information related to a transaction; and
process more than one credit-authorization request at the same time with the computer.

15. The computer system of claim 14, being further operable to return a credit-authorization status responsive to each credit-authorization request.

16. The computer system of claim 14, being further operable to:
open a credit-authorization module for each authorization request;
process each credit-authorization request in a different module; and
return a credit-authorization status responsive to each credit-authorization request.

17. The computer system of claim 16, each module being further operable to:
communicate a credit-authorization request to a credit issuer; and
receive a response to the credit-authorization request from the credit issuer.

18. The computer system of claim 14, wherein the computer system is further operable to receive the plurality of credit-authorization requests from a second computer.

19. The computer system of claim 14, wherein the computer system is further operable to receive the credit-authorization requests received from at least two different e-commerce servers.

20. An e-commerce system, comprising:
a first server operable to communicate with and to receive credit information related to a transaction from a plurality of customer clients;
a second server operable to communicate with the first server and receive a plurality of credit-authorization requests from the first server, each credit-authorization request including credit information related to a transaction, the second computer including a credit-authorization application operable to:
process more than one credit-authorization request at the same time; and provide a credit-authorization status responsive to each credit-authorization request to the another computer system.

21. The system of claim 20, wherein the credit-authorization application is further operable to simultaneously run a plurality of instances of a credit-authorization module, each module being operable to receive and process a request for credit authorization.

22. A method of real-time credit-authorization, the method comprising the steps of:
receiving, in a computer, credit information related to a transaction provided by another computer comprising an e-commerce application, the credit information including a transaction price, a customer identification, and a credit-issuer identification;
opening an instance of a credit-authorization module in the computer;
processing the credit information related to the transaction in the module, including the steps of
ascertaining an availability of the credit issuer for receiving the credit information;
if the credit issuer is available, providing the credit information to the credit issuer and requesting a credit authorization, otherwise storing the credit information for later communication with the credit issuer and returning an authorization-in-process status;
receiving a response to the provided credit information and credit-authorization request from the credit issuer; and
returning a credit-authorization status responsive to the credit-authorization request.

23. The method of claim 22, wherein the step of returning the credit-authorization status includes a further step of the providing the return to the another computer.

24. The method of claim 22, wherein the opening step further includes a step of opening another instance of the module for simultaneously processing another instance of credit information related to a transaction received by the credit-authorization application.
